(19) United States
(12) Patent Application Publication
(10) Pub. No.: US 2007/0085775 A1
(43) Pub. Date: Apr. 19, 2007

(54) Plasma display apparatus

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/546,354

(22) Filed: Oct. 12, 2006

(30) Foreign Application Priority Data
Oct. 14, 2005 (KR) 10-2005-0097105

(51) Int. Cl. G09G 3/28

(52) U.S. Cl. 345/68

(57) ABSTRACT

A plasma display apparatus is disclosed. The plasma display apparatus includes a plasma display panel, a source capacitor, an inductor, and an energy recovery/supply controller. The source capacitor supplies energy to the plasma display panel, and recovers energy from the plasma display panel. The inductor is connected in series to the source capacitor. The energy recovery/supply controller is connected between the plasma display panel and the inductor, for forms an energy supply path and an energy recovery path.

This Nonprovisional application claims priority under 35 U.S.C. § 119(a) on Patent Application No. 0-2005-0097105 filed in Korea on Oct. 14, 2005 the entire contents of which are hereby incorporated by reference.

### BACKGROUND

1. Field

This document relates to a display apparatus, and more particularly, to a plasma display apparatus.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs forms unit discharge cell or discharge cells. Each of discharge cells is filled with an inert gas containing a main discharge gas such as neon (Ne), helium (He) and a mixture of Ne and He and a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultraviolet light, which thereby causes phosphors formed between the barrier ribs to emit light, thus displaying an image. Since the plasma display panel can be manufactured to be thin and light, it has attracted attention as a next generation display device.

The plasma display panel thus driven requires a high voltage of several hundreds of volts in generating an address discharge and a sustain discharge. Accordingly, it is necessary to minimize a driving voltage. For this, the plasma display apparatus generally adopts an energy recovery circuit as a driving circuit.

The energy recovery circuit recovers charges accumulated on a scan electrode, charges accumulated on a sustain electrode, and charges accumulated on an address electrode, and reuses the recovered charges in the driving of a next cycle.

However, an unnecessary resonance waveform is caused by an inductor of the related art energy recovery circuit, thereby increasing power consumption and damaging components of the plasma display apparatus.

### SUMMARY OF THE INVENTION

In one aspect, a plasma display apparatus comprises a plasma display panel, a source capacitor for supplying energy to the plasma display panel, and for recovering energy from the plasma display panel, an inductor connected in series to the source capacitor, and an energy recovery/supply controller, connected between the plasma display panel and the inductor, for forming an energy supply path and an energy recovery path.

In another aspect, a plasma display apparatus comprises a plasma display panel, a source capacitor for supplying energy to the plasma display panel, and for recovering energy from the plasma display panel, an inductor connected in series to the source capacitor, an energy recovery/supply controller, connected between the plasma display panel and the inductor, for forming an energy supply path and an energy recovery path, and a first filter unit connected between a common terminal of the inductor and the energy recovery/supply controller and a ground level voltage source.

In still another aspect, a plasma display apparatus comprises a plasma display panel, a source capacitor for supplying energy to the plasma display panel, and for recovering energy from the plasma display panel, an energy recovery/supply controller, connected between the plasma display panel and the source capacitor, for forming an energy supply path and an energy recovery path, a first inductor connected between the source capacitor and the energy recovery/supply controller and formed on the energy supply path, and a second inductor connected between the source capacitor and the energy recovery/supply controller and formed on the energy recovery path.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is an exploded perspective view of the structure of a plasma display panel of a plasma display apparatus according to embodiments;

FIG. 2 is a plane view of the disposition structure of each of an electrode line and a discharge cell of the plasma display panel illustrated in FIG. 1;

FIGS. 3a and 3b illustrate an energy recovery circuit of a plasma display apparatus according to a first embodiment;

FIGS. 4a and 4b illustrate an energy recovery circuit of a plasma display apparatus according to a second embodiment;

FIG. 5 illustrates an energy recovery circuit of a plasma display apparatus according to a third embodiment; and

FIG. 6 illustrates an energy recovery circuit of a plasma display apparatus according to a fourth embodiment

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel, a source capacitor for supplying energy to the plasma display panel, and for recovering energy from the plasma display panel, an inductor connected in series to the source capacitor, and an energy recovery/supply controller, connected between the plasma display panel and the inductor, for forming an energy supply path and an energy recovery path.

The energy recovery/supply controller may comprise an energy supply controller for forming the energy supply path for supplying energy to the plasma display panel, and an energy recovery controller for forming the energy recovery path for recovering energy from the plasma display panel. The energy supply controller may comprise a first switch and a first diode, and the energy recovery controller may comprise a second switch and a second diode.

The energy supply path may pass through the source capacitor, the inductor, and the energy supply controller.

The energy recovery path may pass through the energy recovery controller, the inductor, and the source capacitor.

A plasma display apparatus comprises a plasma display panel, a source capacitor for supplying energy to the plasma display panel, and for recovering energy from the plasma display panel, an inductor connected in series to the source capacitor, an energy recovery/supply controller, connected between the plasma display panel and the inductor, for forming an energy supply path and an energy recovery path, and a first filter unit connected between a common terminal of the inductor and the energy recovery/supply controller and a ground level voltage source.

The first filter unit may comprise a first capacitor and a first resistor.

The plasma display apparatus may further comprise a second filter unit connected between a common terminal of the inductor and the energy recovery/supply controller and a sustain voltage source.

The second filter unit may comprise a second capacitor and a second resistor.

The energy recovery/supply controller may comprise an energy supply controller for forming the energy supply path for supplying energy to the plasma display panel, and an energy recovery controller for forming the energy recovery path for recovering energy from the plasma display panel. The energy supply controller may comprise a first switch and a first diode, and the energy recovery controller may comprise a second switch and a second diode.

The first switch may be turned off during the supplying a sustain voltage to the plasma display panel, and the second switch may be turned off during the supplying a ground level voltage to the plasma display panel.

The energy supply path may pass through the source capacitor, the inductor, and the energy supply controller.

The energy recovery path may pass through the energy recovery controller, the inductor, and the source capacitor.

A plasma display apparatus comprises a plasma display panel, a source capacitor for supplying energy to the plasma display panel, and for recovering energy from the plasma display panel, an energy recovery/supply controller, connected between the plasma display panel and the source capacitor, for forming an energy supply path and an energy recovery path, a first inductor connected between the source capacitor and the energy recovery/supply controller and formed on the energy supply path, and a second inductor connected between the source capacitor and the energy recovery/supply controller and formed on the energy recovery path.

Inductance of the first inductor may be less than inductance of the second inductor.

The energy recovery/supply controller may comprise an energy supply controller for forming the energy supply path for supplying energy to the plasma display panel, and an energy recovery controller for forming the energy recovery path for recovering energy from the plasma display panel. The energy supply controller may comprise a first switch and a first diode, and the energy recovery controller may comprise a second switch and a second diode.

The first switch may be turned off during the supplying a sustain voltage to the plasma display panel, and the second switch may be turned off during the supplying a ground level voltage to the plasma display panel.

The energy supply path may pass through the source capacitor, the first inductor, and the energy supply controller.

The energy recovery path may pass through the energy recovery controller, the second inductor, and the source capacitor.

Hereinafter, exemplary embodiments of the present invention will be described in detail with reference to the attached drawings.

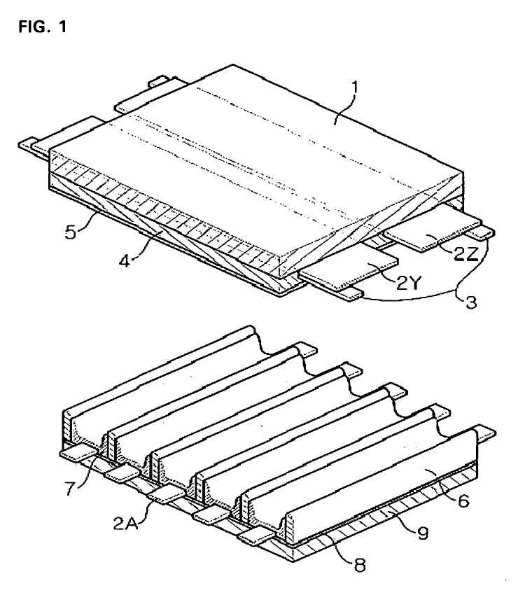

FIG. 1 is an exploded perspective view of the structure of a plasma display panel of a plasma display apparatus according to embodiments.

As illustrated in FIG. 1, each discharge cell comprises a scan electrode 2Y and a sustain electrode 2Z formed on an upper substrate 1, and an address electrode 2A formed on a lower substrate 9.

The scan electrode 2Y and the sustain electrode 2Z are generally formed of transparent indium-tin-oxide (ITO). To reduce voltage drop caused by a high resistance of the transparent ITO, a bus electrode 3 made of a metal such as Cr is formed on the transparent ITO layers of the scan electrode 2Y and the sustain electrode 2Z.

An upper dielectric layer 4 and a protective layer 5 are laminated on the upper substrate 1, on which the scan electrode 2Y and the sustain electrode 2Z are formed in parallel. The protective layer 5 is generally made of MgO to prevent a damage to the upper dielectric layer 4 caused by sputtering generated when generating a plasma discharge and to increase a secondary electron emission coefficient.

A lower dielectric layer 8 and a barrier rib 6 are formed on the lower substrate 9 on which the address electrode 2A is formed. A phosphor 7 is coated on the surfaces of the lower dielectric layer 8 and the barrier rib 6. The address electrode 2A is formed in perpendicular to the scan electrode 2Y and the sustain electrode 2Z. The barrier rib 6 is formed in parallel to the address electrode 2A, thereby preventing ultraviolet rays and visible light generated when generating the plasma discharge from leaking into an adjacent discharge cell.

The phosphor 7 is excited by the ultraviolet rays generated when generating the plasma discharge, thereby generating at least one of red (R) visible light, green (G) visible light or blue (B) visible light. A discharge space (i.e., the discharge cell) formed by the upper substrate 1, the lower substrate 9 and the barrier rib 6 is filled with a penning gas of Ne and Xe, and the like, for a gas discharge.

The discharge cell to be discharged is selected by performing an opposite discharge (i.e., an address discharge) between the address electrode 2A and the scan electrode 2Y. Then, the discharge in the selected discharge cell is maintained by performing a surface discharge (i.e., a sustain discharge) between the scan electrode 2Y and the sustain electrode 2Z.

The visible light is emitted to the outside of the discharge cell by exciting the phosphor 7 using the ultraviolet rays generated when generating the sustain discharge in the discharge cell. As a result, a duration of a maintenance period of the sustain discharge in the discharge cell is adjusted, thereby achieving a gray level of an image. The image is displayed on the plasma display panel in which the discharge cells are arranged in a matrix shape.

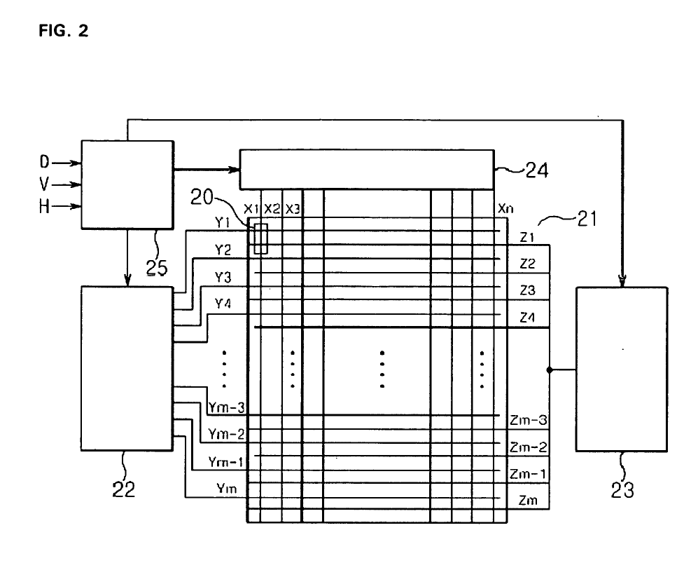

FIG. 2 is a plane view of the disposition structure of each of an electrode line and a discharge cell of the plasma display panel illustrated in FIG. 1.

As illustrated in FIG. 2, the plasma display apparatus comprises a plasma display panel 21, a scan driving circuit 22, a sustain driving circuit 23, an address driving circuit 24, and a control circuit 25. In the plasma display panel 21, m×n discharge cells 20 are disposed in a matrix shape such that scan electrode lines Yl to Ym, sustain electrode lines Zl to Zm, and address electrode lines Xl to Xn are connected to one another in each of the m×n discharge cells 20. The scan driving circuit 22 drives the scan electrode lines Yl to Ym. The sustain driving circuit 23 drives the sustain electrode lines Zl to Zm. The address driving circuit 24 drives the address electrode lines Xl to Xn. The control circuit 25 supplies each of the driving circuit 22, 23 and 24 a control signal based on display data D, a horizontal synchronization signal H, a vertical synchronization signal V, a clock signal, and the like, which are input from the outside.

The scan driving circuit 22 sequentially supplies a reset pulse for uniformalizing initialization states of all the discharge cells, a scan pulse for selecting cells to be discharged, and a sustain pulse for representing gray level depending on the number of discharges to the scan electrode lines Yl to Ym, thereby sequentially scanning the discharge cells 20 in line unit and maintaining a discharge in each of the m×n discharge cells 20.

The sustain driving circuit 23 supplies a sustain pulse to all the sustain electrode lines Zl to Zm, thereby generating a sustain discharge in the selected discharge cells. The scan driving circuit 22 and the sustain driving circuit 23 alternately operate.

The address driving circuit 24 supplies an address pulse synchronized with the scan pulse supplied to the scan electrode lines Yl to Ym to the address electrode lines Xl to Xn, thereby selecting the cells to be discharged.

The plasma display apparatus thus driven requires a high voltage of several hundreds of volts in generating the address discharge and the sustain discharge.

Accordingly, it is necessary to minimize a driving voltage. For this, the scan driving circuit 22, the sustain driving circuit 23, and the address driving circuit 24 each adopt an energy recovery circuit.

The energy recovery circuit recovers charges accumulated on the scan electrode lines, charges accumulated on the sustain electrode lines, and charges accumulated on the address electrode lines, and reuses the recovered charges in the driving of a next cycle. Such a function of the energy recovery circuit will be described in detail below.

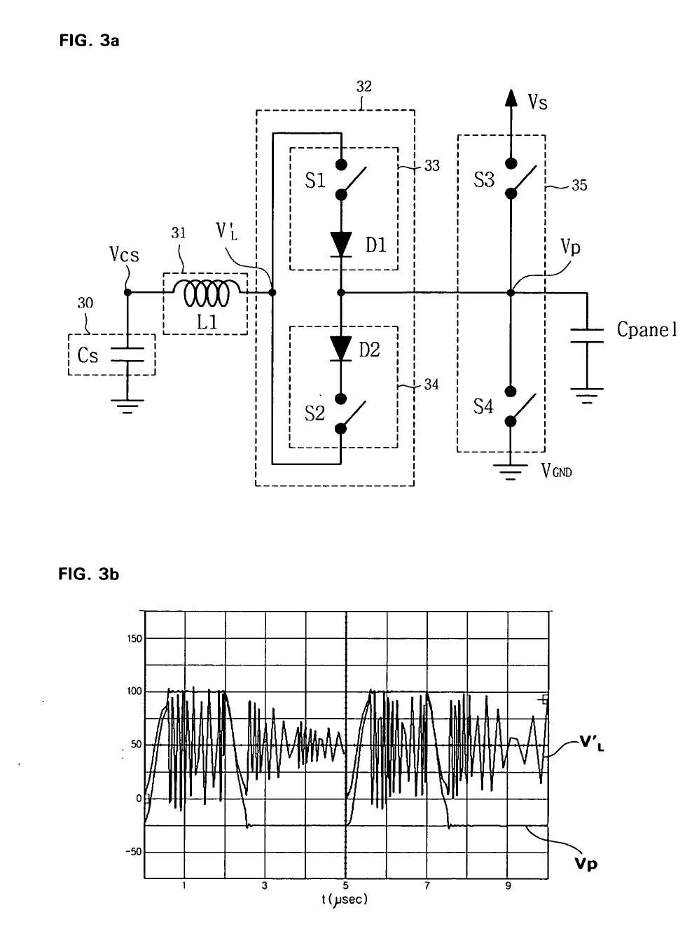

FIGS. 3a and 3b illustrate an energy recovery circuit of a plasma display apparatus according to a first embodiment.

FIG. 3a schematically illustrates a sustain driving circuit comprising the energy recovery circuit according to the first embodiment.

The energy recovery circuit according to the first embodiment comprises a source capacitor 30, an inductor 31, an energy recovery/supply controller 32, and a sustain pulse supply controller 35.

One terminal of the source capacitor 30(Cs) is connected to a ground level voltage V_{GND} and the other terminal is connected to the inductor 31 such that energy is supplied to the plasma display panel Cpanel and energy is recovered from the plasma display panel Cpanel.

The inductor 31 is connected between the source capacitor 30(Cs) and the energy recovery/supply controller 32 such that the inductor 31 is connected in series to the source capacitor 30(Cs).

The energy recovery/supply controller 32 comprises an energy supply controller 33 and an energy recovery controller 34.

The energy supply controller 33 comprises a first switch S1 and a first diode D1. The energy recovery controller 34 comprises a second switch S2 and a second diode D2.

The sustain pulse supply controller 35 comprises a third switch S3 and a fourth switch S4. The third switch S3 and the fourth switch S4 are connected to a sustain voltage source (not illustrated) and a ground level voltage source (not illustrated), respectively such that a sustain voltage Vs and the ground level voltage V_{GND} are supplied to the plasma display panel Cpanel.

The energy recovery circuit of the plasma display apparatus according to the first embodiment roughly performs four operation steps.

It is assumed that a voltage of the plasma display panel Cpanel is equal to 0V and a charge voltage to the source capacitor Cs is equal to Vs/2.

In a first step, the first switch S1 is turned on and the second to fourth switches S2 to S4 are turned off such that an energy supply path passing through the source capacitor Cs, the inductor L1, the first switch S1, and the fist diode D1 are formed. Although the switches are illustrated in a switch type in FIG. 3a, the switches of FIG. 3a indicate a transistor comprising a body diode except a case where the switches are defined differently.

The inductor L1 and the plasma display panel Cpanel form a series resonance circuit. Since the charge voltage to the source capacitor Cs is equal to Vs2, a charging operation and a discharging operation of the inductor L1 of the series resonance circuit raise a voltage Vp to be output to the plasma display panel Cpanel to a voltage (i.e., the sustain voltage Vs) corresponding to two times the charge voltage Vs/2 to the source capacitor Cs.

In a second step, the first switch S1 and the third switch S3 are turned on, and the second switch S2 and the fourth switch S4 are turned off.

As a result, the voltage Vp of the plasma display panel Cpanel is equal to the sustain voltage Vs. The moment the first step is completed (i.e., the voltage Vp of the plasma display panel Cpanel is equal to the sustain voltage Vs by LC resonance), the voltage Vp of the plasma display panel Cpanel is maintained at the sustain voltage Vs for a predetermined duration of time after supplying the sustain voltage Vs to the plasma display panel Cpanel from the sustain voltage source (not illustrated).

In a third step, the second switch S2 is turned on, and the first switch S1, the third switch S3, and the fourth switch S4 are turned off. As a result, energy stored in the plasma display panel Cpanel is discharged. While the discharged energy is stored in the source capacitor Cs, the voltage Vp of the plasma display panel Cpanel is dropped.

In the third step, an energy recovery path passing through the plasma display panel Cpanel, the second diode D2, the second switch S2, the inductor L1, and the source capacitor Cs is formed.

In a fourth step, the second switch S2 and the fourth switch S4 are turned on, and the first switch S1 and the third switch S3 are turned off. As a result, the voltage Vp of the plasma display panel Cpanel is equal to the ground level voltage V_{GND}.

The moment the third step is completed (i.e., the voltage Vp of the plasma display panel Cpanel is equal to the ground level voltage V_{GND} by LC resonance), the voltage Vp of the plasma display panel Cpanel is maintained at the ground level voltage V_{GND} for a predetermined duration of time after supplying the ground level voltage V_{GND} to the plasma display panel Cpanel from the ground level voltage source (not illustrated).

In the energy recovery circuit of the plasma display apparatus according to the first embodiment, the inductor L1 is directly connected to not the plasma display panel Cpanel but the source capacitor Cs.

On the other hand, in the related art energy recovery circuit, a voltage of the other terminal of the inductor L1 is placed in a floating state during the clamping of the voltage Vp supplied to the plasma display panel Cpanel to the sustain voltage Vs or the ground level voltage V_{GND} thereby generating unnecessary resonance. Therefore, a clamping diode for preventing the unnecessary resonance is required.

However, in the energy recovery circuit of the plasma display apparatus according to the first embodiment, as illustrated in FIG. 3a, a voltage supplied to one terminal of the inductor L1 is changed to a voltage Vcs supplied to the source capacitor Cs.

Further, since the voltage Vcs supplied to the source capacitor Cs for performing the energy supply and recovery functions is fixed, the unnecessary resonance is not generated.

The inductor L1 is separated from the plasma display panel Cpanel by the first switch S1 of the energy supply controller 33 and the second switch S2 of the energy recovery controller 34, which are turned off during the maintaining of the voltage of the plasma display panel Cpanel at the sustain voltage Vs and the ground level voltage V_{GND} (i.e., during the operations of the second step and the fourth step). Therefore, a voltage V'L of the other terminal of the inductor L1 does not affect the voltage Vp supplied to the plasma display panel Cpanel such that the clamping diode is not required.

FIG. 3b is a waveform diagram indicating an operation property of the energy recovery circuit illustrated in FIG. 3a.

Referring to FIG. 3b, although the voltage V'L of the other terminal of the inductor L1 irregularly vibrates, the voltage V'L does not affect an output waveform of the voltage Vp supplied to the plasma display panel Cpanel at all.

Further, the voltage V'L of the other terminal of the inductor L1 vibrates within the range of the ground level voltage V_{GND} to the sustain voltage Vs based on the voltage Vs/2. Therefore, the influence of the energy recovery circuit of the plasma display apparatus according to the first embodiment on components adjacent to the energy recovery circuit greatly decreases.

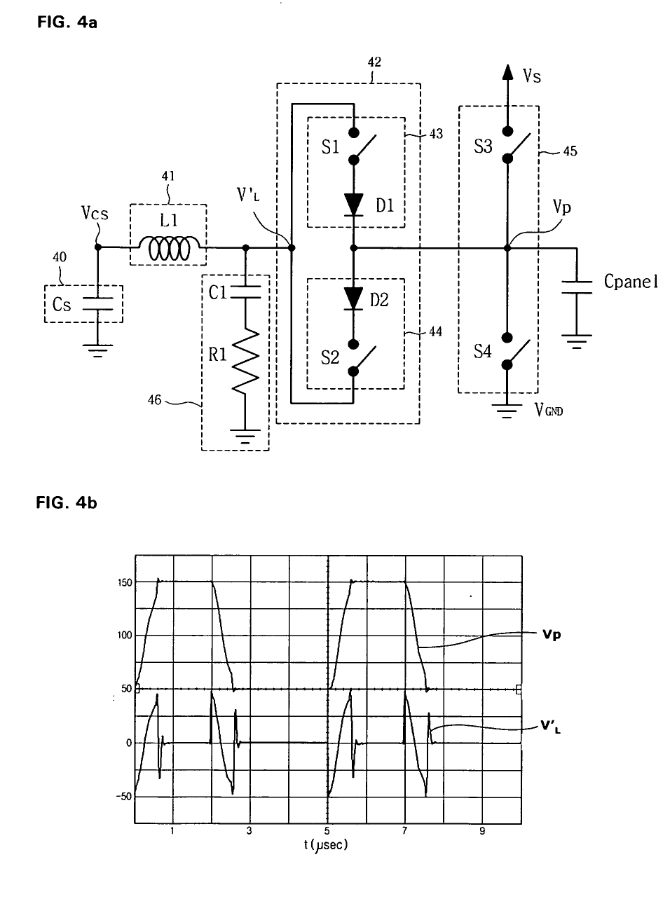

FIG. 4a illustrates a sustain driving circuit comprising an energy recovery circuit according to a second embodiment.

The energy recovery circuit of a plasma display apparatus according to the second embodiment has the same configuration as the energy recovery circuit of the plasma display apparatus according to the first embodiment except a first filter unit 46. The energy recovery circuit according to the second embodiment, similar to the energy recovery circuit according to the first embodiment, has the configuration for reducing the influence of vibration of a voltage V'L of the other terminal of an inductor L1 on a plasma display panel Cpanel. The first filter unit 46 is formed between the other terminal of an inductor L1 and a ground level voltage source (not illustrated). The first filter unit 46 comprises a first resistor R1 and a first capacitor C1 .

In the energy recovery circuit according to the first embodiment, the voltage V'L of the other terminal of the inductor L1 does not affect the output waveform of the plasma display panel Cpanel. However, heat may be generated in the inductor L1 as such. To solve this, the energy recovery circuit according to the second embodiment comprises the first filter unit 46.

In other words, by bypassing a high frequency component induced by the inductor L1 and an energy recovery capacitor Cs to the ground level voltage source using the first filter unit 46, the vibration of the voltage V'L of the other terminal of the inductor L1 within the range of the ground level voltage VGND to the sustain voltage Vs is suppressed.

Although FIG. 4a illustrates the first filter unit 46 having the configuration of a RC filter, it is not limited thereto. The first filter unit 46 may have another band for suppressing a resonance waveform.

FIG. 4b is a waveform diagram for illustrating the reduction in a noise formed in the other terminal of the inductor L1 by bypassing a high frequency component of a resonance waveform formed by a resonance circuit between the inductor L1 and an energy recovery capacitor Cs using the first filter 46 of FIG. 4a.

Referring to FIG. 4b, in the energy recovery circuit according to the second embodiment, the noise in the waveform of the voltage V'L of the other terminal of the inductor L1 greatly decreases in the second step and the fourth step.

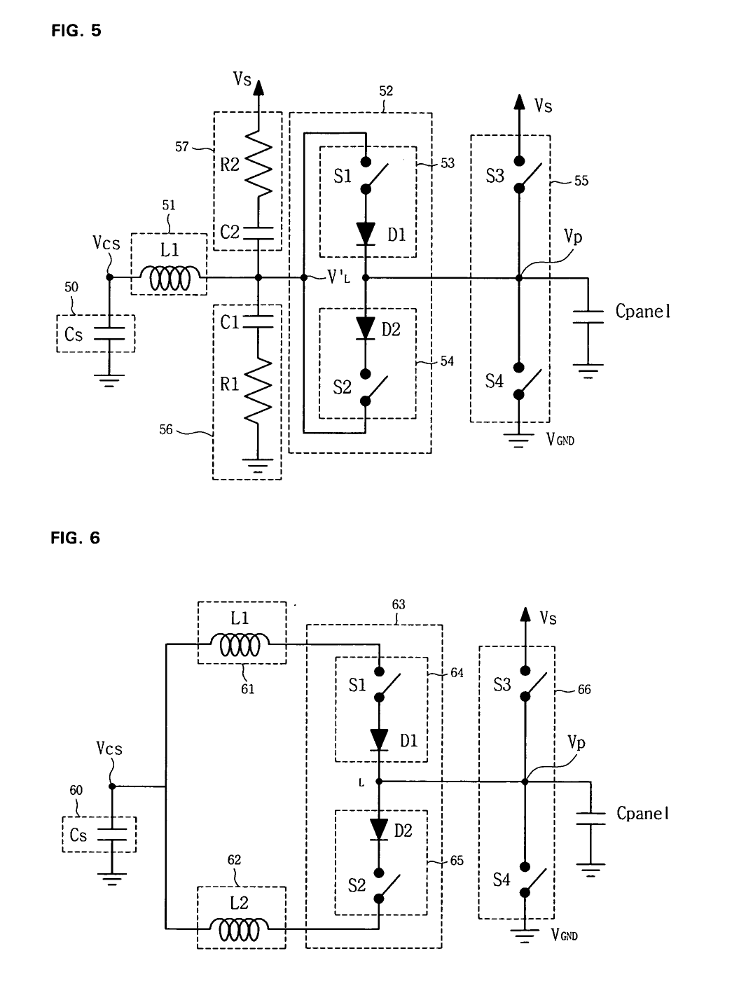

FIG. 5 illustrates an energy recovery circuit of a plasma display apparatus according to a third embodiment. As illustrated in FIG. 5, the energy recovery circuit according to the third embodiment further comprises a second filter unit 57 in addition to a first filter unit 56. The second filter unit 57 is formed between a sustain voltage source (not illustrated) and the other terminal of an inductor L1.

The energy recovery circuit according to the third embodiment comprises the second filter unit 57 for bypassing a high frequency component of a voltage V'L of the other terminal of the inductor L1 to the sustain voltage source, other than the first filter unit 56. Therefore, a noise in two directions of a ground level voltage VGND and a sustain voltage Vs is removed.

FIG. 6 illustrates an energy recovery circuit of a plasma display apparatus according to a fourth embodiment.

As illustrated in FIG. 6, a first inductor L1 for forming an energy supply path and a second inductor L2 for forming an energy recovery path are separated from each other. The first inductor L1 and the second inductor L2 each are directly connected to a source capacitor Cs.

It is preferable that inductance of the first inductor L1 for forming the energy supply path is less than inductance of the second inductor L2 for forming the energy recovery path.

With the above-described configuration, the unnecessary resonance applied to the plasma display panel Cpanel greatly decreases using the inductors L1 and L2 without the use of the clamping diode. Further, since the inductor L1 having a small inductance is used in an energy supply operation (i.e., a first step), a duration of time required to raise a voltage Vp of the plasma display panel Cpanel when supplying energy to the plasma display panel Cpanel decreases. Accordingly, discharge efficiency is improved. Since the energy recovery path is formed using the inductor L2 having a large inductance in an energy recovery operation (i.e., a third step) irrelevant to the discharge efficiency, the discharge efficiency is further improved.

As described above, the plasma display apparatus according to the embodiments prevents the unnecessary resonance applied to the plasma display panel using the inductor. Accordingly, the number of components of the plasma display apparatus decreases, the reliability of the driving circuit increases, and the driving efficiency is improved.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel;
a source capacitor for supplying energy to the plasma display panel, and for recovering energy from the plasma display panel;
an inductor connected in series to the source capacitor, and
an energy recovery/supply controller, connected between the plasma display panel and the inductor, for forming an energy supply path and an energy recovery path.

2. The plasma display apparatus of claim 1, wherein the energy recovery/supply controller comprises an energy supply controller for forming the energy supply path for supplying energy to the plasma display panel, and an energy recovery controller for forming the energy recovery path for recovering energy from the plasma display panel,
wherein the energy supply controller comprises a first switch and a first diode, and the energy recovery controller comprises a second switch and a second diode.

3. The plasma display apparatus of claim 2, wherein the energy supply path passes through the source capacitor, the inductor, and the energy supply controller.

4. The plasma display apparatus of claim 2, wherein the energy recovery path passes through the energy recovery controller, the inductor, and the source capacitor.

5. A plasma display apparatus comprising:
a plasma display panel;
a source capacitor for supplying energy to the plasma display panel, and for recovering energy from the plasma display panel;
an inductor connected in series to the source capacitor,
an energy recovery/supply controller, connected between the plasma display panel and the inductor, for forming an energy supply path and an energy recovery path; and
a first filter unit connected between a common terminal of the inductor and the energy recovery/supply controller and a ground level voltage source.

6. The plasma display apparatus of claim 5, wherein the first filter unit comprises a first capacitor and a first resistor.

7. The plasma display apparatus of claim 5, further comprising a second filter unit connected between a common terminal of the inductor and the energy recovery/supply controller and a sustain voltage source.

8. The plasma display apparatus of claim 7, wherein the second filter unit comprises a second capacitor and a second resistor.

9. The plasma display apparatus of claim 5, wherein the energy recovery/supply controller comprises an energy supply controller for forming the energy supply path for supplying energy to the plasma display panel, and an energy recovery controller for forming the energy recovery path for recovering energy from the plasma display panel,
wherein the energy supply controller comprises a first switch and a first diode, and the energy recovery controller comprises a second switch and a second diode.

10. The plasma display apparatus of claim 9, wherein the first switch is turned off during the supplying a sustain voltage to the plasma display panel, and the second switch is turned off during the supplying a ground level voltage to the plasma display panel.

11. The plasma display apparatus of claim 9, wherein the energy supply path passes through the source capacitor, the inductor, and the energy supply controller.

12. The plasma display apparatus of claim 9, wherein the energy recovery path passes through the energy recovery controller, the inductor, and the source capacitor.

13. A plasma display apparatus comprising:
a plasma display panel;
a source capacitor for supplying energy to the plasma display panel, and for recovering energy from the plasma display panel;
an energy recovery/supply controller, connected between the plasma display panel and the source capacitor, for forming an energy supply path and an energy recovery path;
a first inductor connected between the source capacitor and the energy recovery/supply controller and formed on the energy supply path; and
a second inductor connected between the source capacitor and the energy recovery/supply controller and formed on the energy recovery path.

14. The plasma display apparatus of claim 13, wherein inductance of the first inductor is less than inductance of the second inductor.

15. The plasma display apparatus of claim 13, wherein the energy recovery/supply controller comprises an energy supply controller for forming the energy supply path for supplying energy to the plasma display panel, and an energy recovery controller for forming the energy recovery path for recovering energy from the plasma display panel,
wherein the energy supply controller comprises a first switch and a first diode, and the energy recovery controller comprises a second switch and a second diode.

16. The plasma display apparatus of claim 13, wherein the first switch is turned off during the supplying a sustain voltage to the plasma display panel, and the second switch is turned off during the supplying a ground level voltage to the plasma display panel.

17. The plasma display apparatus of claim 15, wherein the energy supply path passes through the source capacitor, the first inductor, and the energy supply controller.

18. The plasma display apparatus of claim 15, wherein the energy recovery path passes through the energy recovery controller, the second inductor, and the source capacitor.
